(19) United States
(12) Patent Application Publication
(10) Pub. No.: US 2026/0170143 A1
(43) Pub. Date: Jun. 18, 2026

(54) Selective Rule Application Based on Historical Transaction Activity

(71) Applicant: Capital One Services, LLC, McLean, VA (US)

(72) Inventors: Joshua Edwards, Phiadelphia, PA (US); Viral Jogani, Moonachie, NJ (US); Oliver Deighton, Vienna, VA (US); Yao Zhang, Westwood, MA (US); Elizabeth Garner, Potomac, MD (US)

(21) Appl. No.: 18/982,343

(22) Filed: Dec. 16, 2024

(51) Int. Cl. G06F 21/57; G06F 9/46; G06F 21/55

(52) U.S. Cl. CPC G06F 21/577; G06F 9/466; G06F 21/552

(57) ABSTRACT

Systems, methods, and apparatuses are described for applying different security rules to different transactions based on characteristics of similar transactions. A computing device may store different sets of rules applicable to transactions having different security levels, and then process historical transactions to identify characteristics of transactions corresponding to those security levels. The computing device may then receive a request for a new transaction and determine that the new transaction corresponds to a particular security level by comparing characteristics of the new transaction to the characteristics of the various different security levels. The computing device may then determine whether to approve the new transaction by processing the new transaction in accordance with rules corresponding to the particular security level.

### FIELD OF USE

Aspects of the disclosure relate generally to processing requests for high-security transactions. More particularly, aspects described herein describe a process for selectively identifying rules to a transaction based on characterizations of the transaction.

### BACKGROUND

Computers are often tasked with conducting a variety of requested operations, such as transactions (e.g., transmitting some data to a third party, authorizing an electronic transmission of funds, providing access to an account or similar digital content). Those transactions may vary in terms of their importance, and thus in terms of the severity of fraud. For example, requests to e-mail unknown parties or to transmit large quantities of funds might be considered relatively high importance and entail relatively high risk, whereas other requests (e.g., sending a regular e-mail to an internal domain, sending relatively small amounts of funds) might have a relatively lower risk because such activities, at least standing alone, generally might not risk immediate data security/financial/reputational loss. To evaluate the safety of requested transactions, a computing device may apply one or more rules to such transactions to, for example, determine a potential fraud level of the transaction before authorizing the transaction. In this manner, the request transaction(s) may be tested for safety before being allowed to proceed. With that said, there may be circumstances where high-risk transactions should be tested using more permissive rules due to exigent circumstances (e.g., emergencies).

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to applying different security rules to different transactions based on characteristics of similar (e.g., past) transactions. A computing device may be configured to manage different sets of rules for different security levels: for instance, the computing device might maintain a relatively stricter set of rules for high-value transactions (e.g., transfers of large quantities of cryptocurrency or other digital assets, requests to permanently delete content, requests to access high-value network resources), whereas the computing device might also maintain a more permissive set of rules for relatively low-value transactions (e.g., e-mails, low-value financial transactions, e-mail transmissions). The computing device may process historical transactions to identify characteristics of transactions corresponding to different security levels. For example, the computing device might determine characteristics of transactions corresponding to each of the different security levels (e.g., transactions over one million dollars are high-value and thus require one set of rules, whereas transactions under ten dollars do not require significant processing). This process might involve the use of machine learning, such as through use of a machine learning model trained to categorize transactions. The computing device may then receive a request for a new transaction, determine a level appropriate for the transaction based on characteristics of the transaction, and decide whether to approve the transaction based on processing of the transaction based on rules corresponding to the decided level. For example, based on determining that a requested e-mail send transaction corresponds to a high level, characteristics of the e-mail may be tested using a relatively stricter series of rules. With that said, this process may also enable computing devices to identify circumstances where the regularity, importance, or overall severity of transactions might merit more permissive handling. For example, as will be described further below, aspects described herein may enable a computing device to identify circumstances where a transaction that might cause a funds overdraft should be allowed and tested using more permissive rules because such a transaction might correspond to a regular payment (e.g., a rent payment, a car payment) that should not be missed because failure to pay might cause problems (e.g., eviction, repossession) that are significantly more severe than the overdraft. As another example, and as will also be described further below, aspects described herein may enable a computing device to identify circumstances where a transaction might be ordinarily allowable, but might involve an amount of funds that would cause future transactions (e.g., future rent payments, car payments) to overdraft, and might then block such a transaction using a stricter set of rules to ensure that the future transactions can be conducted.

More particularly, and as will be described further below, aspects described herein may be configured to allow potentially harmful transactions to occur based on a perceived importance of the transaction. In some instances, users may request transitions (e.g., the deletion of operating system files, the sending of electronic funds in a manner that causes an account to go to zero or an overdraft) that would, under normal circumstances, be perceived as possibly harmful. That said, if the transaction has characteristics similar to previous transactions (e.g., if the deletion of operating system files is a routine occurrence and/or if the transaction appears to be a necessary rent payment), then the transaction might be allowed. In this manner, larger user needs (e.g., the need to be able to delete a file if desired, the need to pay rent on time and deal with overdraft later) are prioritized, even in circumstances where transactions would be otherwise denied. In some circumstances, this process may hinge on a dynamic categorization process using machine learning, leveraging the ability to process large quantities of past transactions to identify circumstances where transactions should be authorized despite their possible risk. With that said, historical transaction information might also be used to prevent the occurrence of an otherwise allowable transaction, such as if a large transaction (a large luxury goods transaction on the first day of the month that might be wholly permissible under one set of rules) might cause a predicted later transaction (e.g., a rent payment predicted based on a history of past rent payments, such as a determination that rent is always paid on the second of the month) to overdraft.

More particularly, a computing device may store a first set of rules applicable to transactions associated with a first security level and store a second set of rules applicable to transactions associated with a second security level. In such an example, the second set of rules may comprise at least one rule different from the first set of rules. The computing device may then process a plurality of historical transactions corresponding to an account to identify one or more first characteristics of transactions corresponding to the first security level and/or one or more second characteristics of transactions corresponding to the second security level. The computing device may receive, from a second computing device, a request for a new transaction, wherein the new transaction is associated with the account. Then, the computing device may determine that the new transaction corresponds to the first security level by comparing the characteristics of the new transaction to the one or more first characteristics and the one or more second characteristics and determine whether to approve the new transaction by processing the new transaction in accordance with the first set of rules.

The computing device may differentiate security levels of transactions using a trained machine learning model. For example, the computing device may generate a trained machine learning model by training, using the plurality of historical transactions, an artificial neural network comprising a plurality of nodes to differentiate between transactions corresponding to the first security level and transactions corresponding to the second security level. Then, the computing device may determine that the new transaction corresponds to the first security level based on output, from the trained machine learning model, based on the characteristics of the new transaction.

The computing device may compare the characteristics of the new transaction to the characteristics of historical transactions in a variety of ways. For example, the computing device may compare the characteristics of the new transaction to the one or more first characteristics and the one or more second characteristics by identifying a first merchant corresponding to the new transaction, identifying one or more second merchants, different from the first merchant, corresponding to the plurality of historical transactions, and determining, by querying a database, a difference between the first merchant and the one or more second merchants.

As suggested above, the computing device may determine whether to approve the transaction despite the transaction potentially causing some perceived harm. For example, the computing device may determine whether to approve the new transaction by processing the new transaction in accordance with the first set of rules based on a determination that the new transaction, if approved, would cause an overdraft of the account. For instance, the computing device may allow a requested transaction to occur even if it would cause an overdraft if the transaction otherwise satisfies various rules (e.g., rules other than one prohibiting an overdraft). In a similar sense, the computing device may determine whether to approve the transaction based on a perceived level of fraud of the new transaction. For example, as part of processing the new transaction in accordance with the first set of rules, the computing device may determine, based on the characteristics of the new transaction, a predicted fraud level of the new transaction. Along those lines, a transaction might be rejected for a variety of reasons, even if the computing device notices that the transaction is important (e.g., an important recurring transaction, such as a rent payment) based on a fraud level satisfying a threshold.

Different security levels may correspond to different processing standards and different values. For example, the first security level may correspond to a stricter processing standard, whereas the second processing level may correspond to a permissive processing standard. Moreover, such security levels may be associated with perceived value amounts. Along those lines, one or more of the security levels may correspond to various different values (e.g., monetary values). For example, the computing device may determine that the new transaction corresponds to the first security level based on determining that a monetary value corresponding to the new transaction satisfies a threshold.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure

FIG. 3 depicts a method comprising steps for applying different security rules to different transactions based on characteristics of similar transactions.

FIG. 4 depicts an illustrative plurality of historical transactions.

FIG. 5 depicts examples of requested transactions.

FIG. 6 depicts a notification relating to an approved transaction causing an overdraft.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, there may be instances where more permissive rules may be applied to otherwise risky transactions based on characteristics of those transactions. For example, a regularly-conducted e-mail to a company's outside vendor might be quite important (e.g., necessary for regular operations) and might be permitted and processed using less stringent processing rules despite the fact that the company might otherwise maintain relatively strict rules for outgoing e-mails to outside domains. As another example, a transaction associated with payment of rent, an auto payment, or another regular obligation might be quite important (despite involving high amounts of money and possibly risking overdraft), such that the transaction should be allowed more readily than other transactions (as, after all, failure to pay could have significant negative impact). As yet another example, while an e-mail system might implement extremely strict transmission requirements (e.g., e-mails must be compliant with a particular format, sent only to certain users), exigent circumstances (e.g., emergencies during a work conference) might require that those requirements are lessened. Computing devices are generally ill-equipped to identify such circumstances, as rulesets applied to transactions are often quite rudimentary: for example, spam filtering solutions for outgoing e-mails generally are unable to identify the existence of an emergency (particularly one that might counsel for a relaxing of transmission rules), and it can be cumbersome and time-consuming to have information technology professionals manually create exceptions to existing rule bases. Indeed, the ability to make such exceptions on-the-fly is quite important: after all, once the damage is done (e.g., an e-mail is blocked, a rent payment is missed), the consequences can be quite severe.

To provide a particular example of the problems illustrated above from the perspective of financial transactions, assume that a computing device receives a request to transfer funds for a rent payment; however, that the request would cause an overdraft of a financial account. For example, a user might have a regular $2,500 rent payment scheduled on the first of every month, but on the first of an upcoming month the user might only have $2,000 in their account. Under ordinary processing rules (e.g., rules preventing overdraft), such a transaction would be rejected outright. That said, the consequences of such a failed payment (e.g., potential eviction) are significant compared to the consequences of the overdraft (e.g., various fees that could be addressed later). Along those lines, aspects described herein enable computers to identify that the transaction belongs to a special category (e.g., recurring, high-value, important transactions) and to enable the more permissive processing of such transactions even if they are expected to cause an overdraft. In turn, while the requested transaction might be processed using other rules (e.g., those preventing outright fraud), other rules (e.g., those preventing overdraft) might not be applied.

More broadly, to remedy the issues identified above and other issues, aspects described herein enable computing devices to selectively apply different levels of rules to requested transactions based on their similarity to historical transactions, thereby enabling computing devices to make permissive exceptions for those rules where otherwise strict rules might apply. As will be described in greater detail below, a computing device may store various sets of rules, and each may correspond to a different level of strictness (e.g., one set might be very strict, another might be permissive). The computing device may then process a plurality of historical transactions to identify characteristics (e.g., dates, times, requested actions, amount(s) involved) and which of the sets of rules those transactions would fall under. For instance, the computing device may identify certain financial transactions that fall into a permissive category (e.g., necessary/essential transactions such as rent payments, car payments), and other financial transactions that might require more strict handling (e.g., one-time large payments for vacations, luxury goods). This process may entail use of a machine learning model, such as one used to categorize the historical transactions into various categories (e.g., “important, large, and regular” transactions such as rent payments, “unexpected and large” transitions such as purchases of luxury goods, “small and regular” transactions such as coffee purchases, etc.). That said, one advantage of using such a machine learning model is that it might categorize transactions in a nuanced, fine-grained, and otherwise unique way: that is, the machine learning model may be configured to determine a wide variety of transaction categories, allowing for nuanced handling of incoming transactions. The computing device may then receive some request for a new transaction, use the characteristics of that transaction to assign it to a category (e.g., with or without the use of the aforementioned machine learning model), and then process it in accordance with rules corresponding to that category.

For the sake of ease of illustration, many of the examples herein will relate to financial transactions, where characteristics of the transactions (e.g., date, time, amount) are typically quite straightforward and where consequences of the improper approval of a transaction (e.g., theft of funds) or the improper rejection of a transaction (e.g., nonpayment of rent and associated eviction) are severe. With that said, and as already discussed above, aspects described herein may apply to a wide variety of electronic transactions, such as requests to transmit electronic content (e.g., files, e-mails), requests to access electronic content (e.g., log-in requests), or the like.

Aspects described herein improve the functioning of computers by allowing computers to selectively process and approve requests using historical data, machine learning models, and in a manner which can infer overall user priorities without explicitly being provided information about those priorities. Computers are ill-equipped to handle the nuance of transactions, especially when transactions fall into edge cases where ordinary processing rules should be relaxed. By categorizing past transactions and using that as a litmus test for the application of rules to new/requested transactions, the computing device can remedy this deficiency by identifying circumstances where the unnecessary application of overly narrow rulesets may cause unnecessary harm. This process can, in some instances, involve machine learning techniques which allow for the nuanced analysis of transaction categories and rulesets in a manner that would be prohibitively difficult for a human. In turn, even if a human could possibly perform one or more of the concepts described herein (e.g., realizing that a certain transaction is important), it is difficult for a computer to do so, and aspects described herein thereby allow a computing device to do something that it otherwise could not do before.

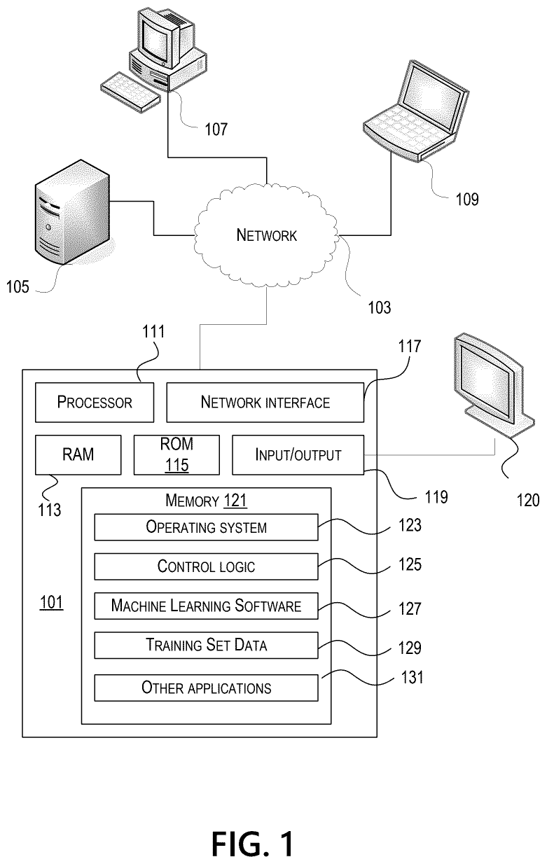

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

FIG. 1 also shows that the computing device 101 may comprise a Hardware Security Module (HSM) 132 and/or a Quantum Random Number Generator (QRNG) 133. The HSM 132 may comprise any computing module (e.g., one or more computer chips, attached cards, or the like) which may be capable of managing secrets, performing encryption and/or decryption, and/or otherwise performing security-and/or authentication-related functions. The HSM 132 may comprise, for instance, one or more secure cryptoprocessor chips which are capable of performing cryptographic operations. The QRNG 133 may comprise any computing module (e.g., one or more computer chips, attached cards, or the like) capable of generating a random number. Such a random number might be generated using quantum methods which permit the random number to have a high degree of entropy.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

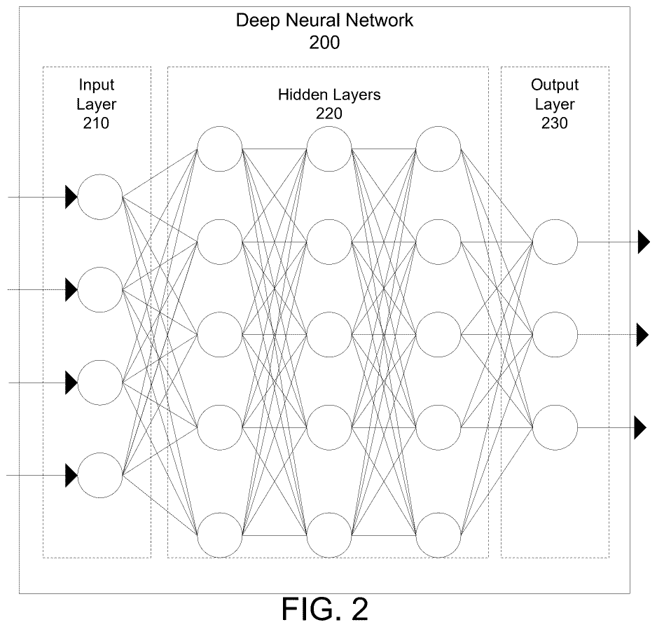

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

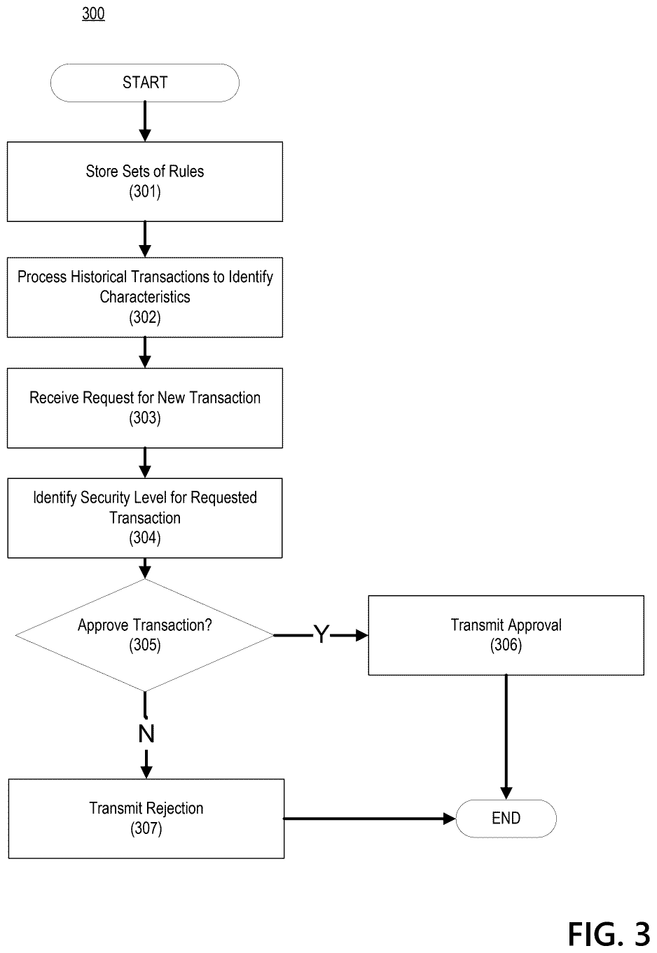

FIG. 3 depicts a method 300 comprising steps for applying different security rules to different transactions based on characteristics of similar transactions which may be performed by a computing device, such as any one of the devices described with respect to FIG. 1 and/or FIG. 2. The steps shown in FIG. 3 are illustrative, and may be re-arranged, omitted, and/or modified as desired. A computing device may comprise one or more processors and memory storing instructions that, when executed by the one or more processors, cause the performance of one or more of the steps depicted in FIG. 3. One or more non-transitory computer-readable media may store instructions that, when executed, cause the performance of one or more of the steps depicted in FIG. 3.

In step 301, a computing device may store sets of rules. Different sets of rules may correspond to different security levels. For example, the computing device may store a first set of rules applicable to transactions associated with a first security level and may store a second set of rules applicable to transactions associated with a second security level. In such an example, the second set of rules may comprise at least one rule different from the first set of rules.

As used herein, a rule may comprise a test, condition, or similar evaluation which may allow a computing device to determine whether to approve or deny a transaction. For example, one rule may prohibit e-mails to outside domains if they contain file attachments, whereas another rule may prohibit e-mails from being sent during certain work hours. As another example, one rule may prohibit transactions which cause overdrafts, whereas another rule may prevent transactions over a certain amount. As yet another example, one rule may prevent file actions associated with operating system files, whereas another rule may limit the nature of file edits made outside of work hours.

Different sets of rules may be configured to be applied to different types of transactions. For example, in the context of e-mail transactions, one set of rules may be applied to regular e-mails within a company, whereas another set of rules may be applied to e-mails sent outside of a corporate network. As another example, in the context of financial transactions, one set of rules may apply to one range of monetary values, whereas another set of rules may apply to another range of monetary values. As another example in the financial context, one set of rules may apply to regular transactions (e.g., rent payments, car payments), whereas another set of rules may apply to irregular transactions (e.g. one-time purchases at luxury stores). As yet another example, in the context of data management, one set of rules might apply to a first set of files (e.g., files in temporary folders), whereas another set of rules may apply to a second set of files (e.g., operating system files).

As used herein, a security level may refer to any subjective characterization of the severity, sensitivity, and/or overall importance of a transaction. A security level may refer to how dangerous a particular transaction might be (e.g., a particularly high dollar amount), how unusual a particular transaction might be (e.g., how frequently such a transaction is likely to occur), or the like. Administrators may vary the number and nature of such security levels to tailor different sets of rules to different situations. For instance, and as will be described below, a machine learning model (e.g., as implemented using the artificial neural network described above with respect to FIG. 2) may be configured to categorize past transactions into security levels/rules, meaning that variation of the number/nature of the security levels may enable an administrator to finely tune how rules are applied, how categorization is performed, and the like.

In step 302, the computing device may process historical transactions to identify characteristics. This process may entail evaluating the characteristics of past transactions to identify which (if any) of the rules/security levels from step 301 they correspond to. For example, the computing device may process a plurality of historical transactions corresponding to an account to identify one or more first characteristics of transactions corresponding to the first security level and/or one or more second characteristics of transactions corresponding to the second security level. This process may be performed even though the past transactions might not have been processed using rules corresponding to identified security levels. For example, a first past transaction of the plurality of historical transactions may be determined to correspond to a particular security level even though the transaction was never processed in accordance with rules corresponding to that particular security level. This might occur quite frequently where, for example, the rules are entirely new, the transactions are quite old, or the like.

As part of processing the historical transitions to identify characteristics, the computing device may train a machine learning model, such as one implemented using the artificial neural network described above with respect to FIG. 2. For example, the computing device may generate a trained machine learning model by training, using the plurality of historical transactions, an artificial neural network comprising a plurality of nodes to differentiate between transactions corresponding to the first security level and transactions corresponding to the second security level. The machine learning model might be a categorization model configured to identify, based on the plurality of historical transactions, categories for all or portions of the plurality of historical transactions. For example, the training process might be unsupervised, such that the trained machine learning model may, on its own, decide a variety of categories for all or portions of the plurality of historical transactions. As another example, the training process might be supervised, meaning that all or portions of the plurality of historical transactions may be tagged as belonging to a particular category.

In step 303, the computing device may receive a request for a new transaction. The request may be received from a different computing device and may indicate a requested transaction that has not yet been categorized into a security level (and/or categorized for processing in accordance with particular rules). For example, the computing device may receive, from a second computing device, a request for a new transaction, wherein the new transaction is associated with the account. Such a request may be received from an operating system (e.g., as part of a user requesting some sort of file operation), through a website or application (e.g., as part of a user requesting to send an e-mail), through a point-of-sale system (e.g., as part of a request for a payment), or the like. For example, the request might be received from an electronic payment system as part of a recurring payment arrangement for rent, a car payment, or the like.

In step 304, the computing device may identify a security level for the requested new transaction. This process may comprise determining, using characteristics of the requested new transaction, which past transactions it is most similar to. For example, the computing device may determine that the new transaction corresponds to the first security level by comparing the characteristics of the new transaction to the one or more first characteristics and the one or more second characteristics. The result of this process might be to associate the requested new transaction with a security level (and, in turn, a set of rules) for further processing.

Identification of a security level for the requested new transaction may comprise use of a machine learning model, such as one trained as part of step 302 and/or one implemented on an artificial neural network such as the artificial neural network described above with respect to FIG. 2. For example, the computing device may determine that the new transaction corresponds to the first security level based on output, from the trained machine learning model, based on the characteristics of the new transaction. In circumstances where the trained machine learning model is a categorization model, the trained machine learning model may, for example, output an indication of a category to which the transaction belongs. With that said, in some other circumstances, the trained machine learning model might instead output a different sort of data, such as an indication of a most similar transaction.

Identification of a security level for the requested new transaction may comprise comparing one or more characteristics of the requested new transaction to a threshold. For example, in the context of file processing, file transactions conducted during work hours may be processed in accordance with a first set of rules and in accordance with a first security level, whereas file transactions conducted outside of work hours may be processed in accordance with a second set of rules and in accordance with a second security level. In turn, the identification of the security level may turn on whether the requested new transaction is within a particular time range. As another example, as indicated above, one set of rules (and, e.g., one security level) may apply to a first range of monetary values, whereas another set of rules (and, e.g., another security level) may apply to a different range of monetary values. In turn, identification of the security level may comprise comparing a characteristic of the requested new transaction (e.g., a monetary amount) to such ranges and/or satisfies a threshold.

The computing device may compare the characteristics of the new transaction to the one or more first characteristics and the one or more second characteristics in a variety of ways. In some instances, this may involve comparing an intended target of the transaction, such as a file to be deleted, a merchant to receive funds, for the like. For example, if the new requested transaction relates to an e-mail address having an untrusted domain (e.g., a non-corporate domain, such as a domain associated with known burner e-mail addresses), then the requested transaction may be processed in accordance with a stricter set of rules as compared to a transaction involving an e-mail address having a trusted domain. As another example, the computing device may identify a first merchant corresponding to the new transaction, identify one or more second merchants, different from the first merchant, corresponding to the plurality of historical transactions, and then determine, by querying a database, a difference between the first merchant and the one or more second merchants.

In step 305, the computing device may determine whether to approve the requested new transaction. This process may involve processing the transaction in accordance with rules corresponding to an identified security level. For example, the computing device may determine whether to approve the new transaction by processing the new transaction in accordance with the first set of rules. If the computing device determines to approve the transaction in step 305, then in step 306, the computing device may transmit an approval of the transaction. That said, if the computing device determines to not approve the transaction as part of step 305, then the computing device may, in step 307, transmit a rejection of the transaction. Such transmissions may be to one or more computing devices (e.g., those described in FIG. 1) and/or via a network (e.g., such as the network 103).

As previously indicated, one advantage of the present process is that, as part of step 305, a transaction may be approved and processed in accordance with a more permissive set of rules even if, under a stricter set of rules, the transaction would be rejected. For instance, the computing device may determine that the new transaction, if approved, would cause an overdraft of the account. Even under such a circumstance, the computing device may ultimately approve the transaction because a more permissive rule set might have been applied and because that permissive rule set might not prohibit transactions that cause overdrafts.

In some circumstances, transactions may be rejected in circumstances where they might otherwise be granted. The above description suggests that, in some circumstances, transactions might be granted under a more permissive set of rules despite the fact that those transactions would ordinarily be blocked (e.g., because they might cause an overdraft). On the other hand, in some circumstances, transactions might be blocked under a stricter set of rules despite the fact that those transactions would ordinarily be allowed. For example, if a transaction is generally permissible but might use up an amount of funds that might likely cause future incoming transactions (e.g., a rent payment the next day) to overdraft, then the transaction might be blocked. In this manner, aspects described herein might provide stricter sets of rules to otherwise permissible transactions in circumstances where those transactions risk the future ability of a user to pay for essential transactions (e.g., rent, car payments, etc.).

Determining whether to approve the requested new transaction may comprise causing modification of a preexisting limitation. Some accounts may be provided financial limitations (e.g., overdraft limitations, transaction quantity limitations, transaction amount limitations). In turn, as part of processing the transaction in accordance with rules corresponding to an identified security level, one or more financial limitations may be modified. For example, an overdraft limit might be increased, a transaction quantity limitation might be increased, a transaction amount limitation might be increased, or the like. This process may be temporary: for example, the overdraft limitation might be increased only for a particular transaction and/or only for a particular time period.

The above being said, the fact that a more permissive set of rules might be applied to a transaction does not mean that the transaction will be automatically allowed. Take, for example, the examples discussed above, where a regular transaction (e.g., a rent payment) is processed using a more permissive rule set that does not prevent the transaction from being completed even if it causes an overdraft. Even in this circumstance, other rules might still be applied. For example, the computing device may determine a predicted fraud level of the new transaction based on the characteristics of the new transaction and, if the predicted fraud level satisfies a threshold, decide to reject the transaction. Stated somewhat differently, the computing device need not be configured to allow all recurring transactions.

The predicted fraud level described above may be determined using one or more rules. For example, at least one of the one or more rules may be configured to identify a fraud level based on, for example, the time of a transaction, user(s) involved in a transaction, data involved in a transaction, or the like. Indeed, a wide variety of different rules may be used to identify a predicted fraud level. In turn, such rules may be used to identify the predicted fraud level, and the rules may be used to determine whether to approve the transaction.

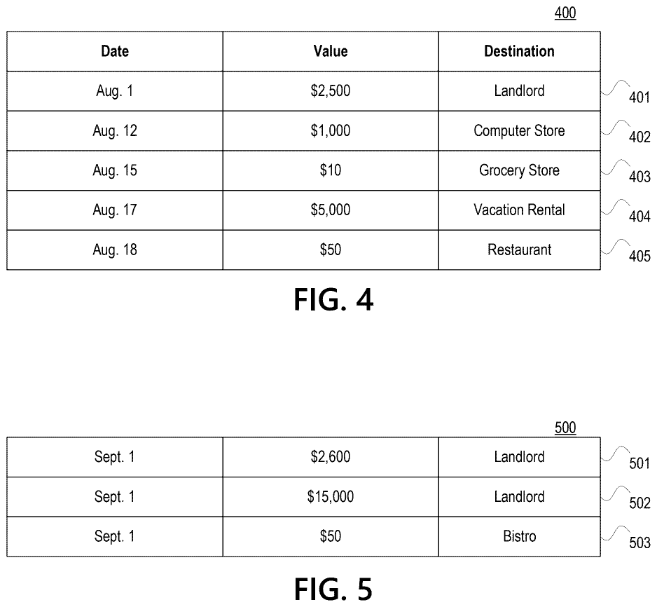

FIG. 4 depicts an illustrative plurality of historical transactions 400. Specifically, the plurality of historical transactions 400 comprises a first transaction 401 indicating a $2,500 payment to a landlord on August 1, a second transaction 402 indicating a $1,000 payment to a computer store on August 12, a third transaction 403 indicating a $10 payment to a grocery store on August 15, a fourth transaction 404 indicating a $5,000 payment to a vacation rental on August 17, and a fifth transaction 405 indicating a $50 payment to a restaurant on August 18. This plurality of historical transactions 400 illustrates how, for a financial account, various different transactions may have been conducted across time, with some transactions (e.g., the first transaction 401 to the landlord) being part of a regular set of payments (e.g., for rent), whereas other transactions (e.g., the fourth transaction 404 to the vacation rental) being more irregular (e.g., a payment for a vacation).

FIG. 5 depicts examples of requested transactions 500. Three requested transactions are depicted: a first requested transaction 501 for a $2,600 payment to a landlord on September 1, a second requested transaction 502 for a $15,000 payment to the landlord on September 1, and a third requested transaction 503 for a $50 payment to a bistro on September 1. Note that these requested transactions may be processed (e.g., in accordance with the steps depicted in FIG. 3) to identify the rules to be applied to each requested transaction. For instance, both the first requested transaction 501 and the second requested transaction 502, by virtue of appearing to be part of a regular scheme of rent payments (e.g., along with the first transaction 401), may be processed using a first set of rules corresponding to a first security level. Indeed, along those lines, even though either or both of the first requested transaction 501 and the second requested transaction 502 may cause an overdraft (e.g., if the account only has $2,000), this might not prevent the transactions from being processed. That said, the fact that the second requested transaction 502 has other indicia of concern (e.g., the unexpected $15,000 value) might cause it to be rejected, whereas the fact that the first requested transaction 501 has a slightly different value than the first transaction 401 might not cause it to be rejected. In other words, while the first requested transaction 501 might be approved in accordance with a first set of rules despite it possibly causing overdraft so long as it satisfies the first set of rules and even if it is slightly different than past similar transactions, the second requested transaction 502 might be denied in accordance with the first set of rules despite it also possibly causing overdraft because it might not satisfy the second set of rules. In contrast, the third requested transaction 503 might be approved or rejected in accordance with an entirely different set of rules.

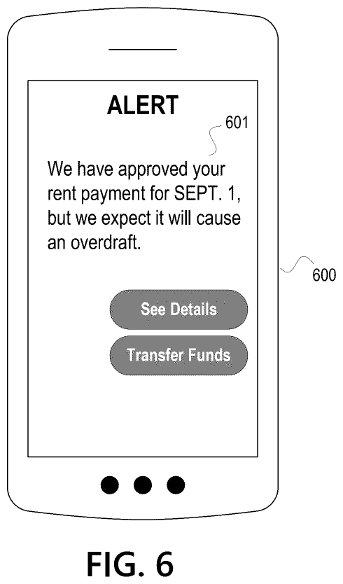

FIG. 6 depicts a notification 601 relating to an approved transaction causing an overdraft being displayed on a mobile device 600. The notification 601 comprises an illustrative example of output that might be transmitted to a user when a routine transaction (e.g., a rent transaction) is approved despite it possibly causing an overdraft. Similar such notifications may be transmitted as necessary, as they might allow a user to anticipate and avoid any undesirable consequences of the approval of the transaction. For example, in the overdraft context, the user might be prompted to add more funds to the account if possible.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to apply different security rules to different transactions based on characteristics of similar transactions, the computing device comprising:
one or more processors; and
memory storing instructions that, when executed by the one or more processors, cause the computing device to:
store a first set of rules applicable to transactions associated with a first security level;
store a second set of rules applicable to transactions associated with a second security level, wherein the second set of rules comprises at least one rule different from the first set of rules;
process a plurality of historical transactions corresponding to an account to identify:
one or more first characteristics of transactions corresponding to the first security level; and
one or more second characteristics of transactions corresponding to the second security level;
receive, from a second computing device, a request for a new transaction, wherein the new transaction is associated with the account;
determine that the new transaction corresponds to the first security level by comparing the characteristics of the new transaction to the one or more first characteristics and the one or more second characteristics; and
determine whether to approve the new transaction by processing the new transaction in accordance with the first set of rules.

2. The computing device of claim 1, wherein the instructions, when executed by the one or more processors, cause the computing device to:
generate a trained machine learning model by training, using the plurality of historical transactions, an artificial neural network comprising a plurality of nodes to differentiate between transactions corresponding to the first security level and transactions corresponding to the second security level, wherein the instructions, when executed by the one or more processors, cause the computing device to determine that the new transaction corresponds to the first security level based on output, from the trained machine learning model, based on the characteristics of the new transaction.

3. The computing device of claim 1, wherein the comparing the characteristics of the new transaction to the one or more first characteristics and the one or more second characteristics comprises:
identifying a first merchant corresponding to the new transaction;
identifying one or more second merchants, different from the first merchant, corresponding to the plurality of historical transactions; and
determining, by querying a database, a difference between the first merchant and the one or more second merchants.

4. The computing device of claim 1, wherein the instructions, when executed by the one or more processors, cause the computing device to determine whether to approve the new transaction by processing the new transaction in accordance with the first set of rules based on a determination that the new transaction, if approved, would cause an overdraft of the account.

5. The computing device of claim 1, wherein the first security level corresponds to a stricter processing standard, wherein the second security level corresponds to a permissive processing standard, and wherein the instructions, when executed by the one or more processors, cause the computing device to determine that the new transaction corresponds to the first security level based on determining that a monetary value corresponding to the new transaction satisfies a threshold.

6. The computing device of claim 1, wherein the processing the new transaction in accordance with the first set of rules comprises determining, based on the characteristics of the new transaction, a predicted fraud level of the new transaction.

7. The computing device of claim 1, wherein the instructions, when executed by the one or more processors, cause the computing device to determine whether to approve the new transaction by causing the computing device to:
transmit a rejection of the new transaction.

8. A method configured to apply different security rules to different transactions based on characteristics of similar transactions, the method comprising:
storing a first set of rules applicable to transactions associated with a first security level;
storing a second set of rules applicable to transactions associated with a second security level, wherein the second set of rules comprises at least one rule different from the first set of rules;
processing a plurality of historical transactions corresponding to an account to identify:
one or more first characteristics of transactions corresponding to the first security level; and
one or more second characteristics of transactions corresponding to the second security level;
receiving, from a second computing device, a request for a new transaction, wherein the new transaction is associated with the account;
determining that the new transaction corresponds to the first security level by comparing characteristics of the new transaction to the one or more first characteristics and the one or more second characteristics; and
determining whether to approve the new transaction by processing the new transaction in accordance with the first set of rules.

9. The method of claim 8, further comprising:
generating a trained machine learning model by training, using the plurality of historical transactions, an artificial neural network comprising a plurality of nodes to differentiate between transactions corresponding to the first security level and transactions corresponding to the second security level, wherein the determining that the new transaction corresponds to the first security level is based on output, from the trained machine learning model, based on the characteristics of the new transaction.

10. The method of claim 8, wherein the comparing the characteristics of the new transaction to the one or more first characteristics and the one or more second characteristics comprises:
identifying a first merchant corresponding to the new transaction;
identifying one or more second merchants, different from the first merchant, corresponding to the plurality of historical transactions; and
determining, by querying a database, a difference between the first merchant and the one or more second merchants.

11. The method of claim 8, wherein the determining whether to approve the new transaction by processing the new transaction in accordance with the first set of rules is based on a determination that the new transaction, if approved, would cause an overdraft of the account.

12. The method of claim 8, wherein the first security level corresponds to a stricter processing standard, wherein the second security level corresponds to a permissive processing standard, and wherein the determining that the new transaction corresponds to the first security level is based on determining that a monetary value corresponding to the new transaction satisfies a threshold.

13. The method of claim 8, wherein the processing the new transaction in accordance with the first set of rules comprises determining, based on the characteristics of the new transaction, a predicted fraud level of the new transaction.

14. The method of claim 8, wherein the determining whether to approve the new transaction comprises:
transmitting a rejection of the new transaction.

15. One or more non-transitory computer-readable media storing instructions configured to apply different security rules to different transactions based on characteristics of similar transactions, wherein the instructions, when executed by one or more processors of a computing device, cause the computing device to:
store a first set of rules applicable to transactions associated with a first security level;
store a second set of rules applicable to transactions associated with a second security level, wherein the second set of rules comprises at least one rule different from the first set of rules;
process a plurality of historical transactions corresponding to an account to identify:
one or more first characteristics of transactions corresponding to the first security level; and
one or more second characteristics of transactions corresponding to the second security level;
receive, from a second computing device, a request for a new transaction, wherein the new transaction is associated with the account;
determine that the new transaction corresponds to the first security level by comparing characteristics of the new transaction to the one or more first characteristics and the one or more second characteristics; and
determine whether to approve the new transaction by processing the new transaction in accordance with the first set of rules.

16. The one or more non-transitory computer-readable media of claim 15, wherein the instructions, when executed by the one or more processors, cause the computing device to:
generate a trained machine learning model by training, using the plurality of historical transactions, an artificial neural network comprising a plurality of nodes to differentiate between transactions corresponding to the first security level and transactions corresponding to the second security level, wherein the instructions, when executed by the one or more processors, cause the computing device to determine that the new transaction corresponds to the first security level based on output, from the trained machine learning model, based on the characteristics of the new transaction.

17. The one or more non-transitory computer-readable media of claim 15, wherein the comparing the characteristics of the new transaction to the one or more first characteristics and the one or more second characteristics comprises:
identifying a first merchant corresponding to the new transaction;
identifying one or more second merchants, different from the first merchant, corresponding to the plurality of historical transactions; and
determining, by querying a database, a difference between the first merchant and the one or more second merchants.

18. The one or more non-transitory computer-readable media of claim 15, wherein the instructions, when executed by the one or more processors, cause the computing device to determine whether to approve the new transaction by processing the new transaction in accordance with the first set of rules based on a determination that the new transaction, if approved, would cause an overdraft of the account.

19. The one or more non-transitory computer-readable media of claim 15, wherein the first security level corresponds to a stricter processing standard, wherein the second security level corresponds to a permissive processing standard, and wherein the instructions, when executed by the one or more processors, cause the computing device to determine that the new transaction corresponds to the first security level based on determining that a monetary value corresponding to the new transaction satisfies a threshold.

20. The one or more non-transitory computer-readable media of claim 15, wherein the processing the new transaction in accordance with the first set of rules comprises determining, based on the characteristics of the new transaction, a predicted fraud level of the new transaction.
